(19) United States
(12) Patent Application Publication
(10) Pub. No.: US 2002/0189547 A1
(43) Pub. Date: Dec. 19, 2002

(54) Illuminated milking parlor stalls and method

(76) Inventors: Paul A. Eppers, Madison, WI (US); Joseph G. Prazak, Sun Prairie, WI (US); Josh J. Vrieze, Madison, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/880,372

(22) Filed: Jun. 13, 2001

(51) Int. Cl. A01J 3/00

(52) U.S. Cl. 119/14.03

(57) ABSTRACT

Milking parlor stalls (22, 24, 26) are provided with lights (62, 64, 80, 82, 84, 90, 92, 98, 100, 102) directly illuminating the cows' udders (34). The lights are spaced from the udders along illumination paths including rectilinear paths unblocked by the cows' body above the udder.

### BACKGROUND AND SUMMARY OF THE INVENTION

The invention relates to milking parlors, and more particularly to improved illumination of the cow's udder.

The invention arose during continuing development efforts in milking parlors, including herringbone, parabone, parallel and rotary parlors, particularly illumination thereof. Lighting fixtures in milking parlors are typically suspended overhead, and the light is not able to reach some of the operator's working area effectively, particularly the cow's udder because it is blocked by the body of the cow, and may also be blocked by various parlor and stall components and structure, i.e., the udder is in the shadows. Much of the operator's time is spent looking underneath the cow at the udder, and hence the shadowed condition causes fatigue and eye strain.

The present invention addresses and solves the noted illumination problem in a particularly simple and effective manor. Eye fatigue and strain is reduced, as well as enabling the operator to do a better job of prepping and attaching milking cluster units, and also enabling the operator to more readily identify problems with the cow's milk, e.g., mastitis, chunky milk, etc., which in turn increases the overall quality of the milk produced.

### BRIEF DESCRIPTION OF THE DRAWINGS

FIG. 1 is a top view of a milking parlor known in the prior art.

FIG. 2 is a side view taken along line 2-2 of FIG. 1.

FIG. 3 is a top view of a milking parlor in accordance with the present invention.

FIG. 4 is a perspective view of the parlor of FIG. 3.

FIG. 5 is a side view taken along line 5-5 of FIG. 3.

FIG. 6 is a side view taken along line 6-6 of FIG. 3.

FIG. 7 is a perspective view of the parlor of FIG. 3 taken from below and in the pit.

FIG. 8 is a view taken along line 8-8 of FIG. 7.

FIG. 9 is a view like FIG. 4, and shows an alternate embodiment.

FIG. 10 is a view taken along line 10-10 of FIG. 9 FIG. 11 is a side view of a parlor, and shows an alternate embodiment.

### DETAILED DESCRIPTION OF THE INVENTION

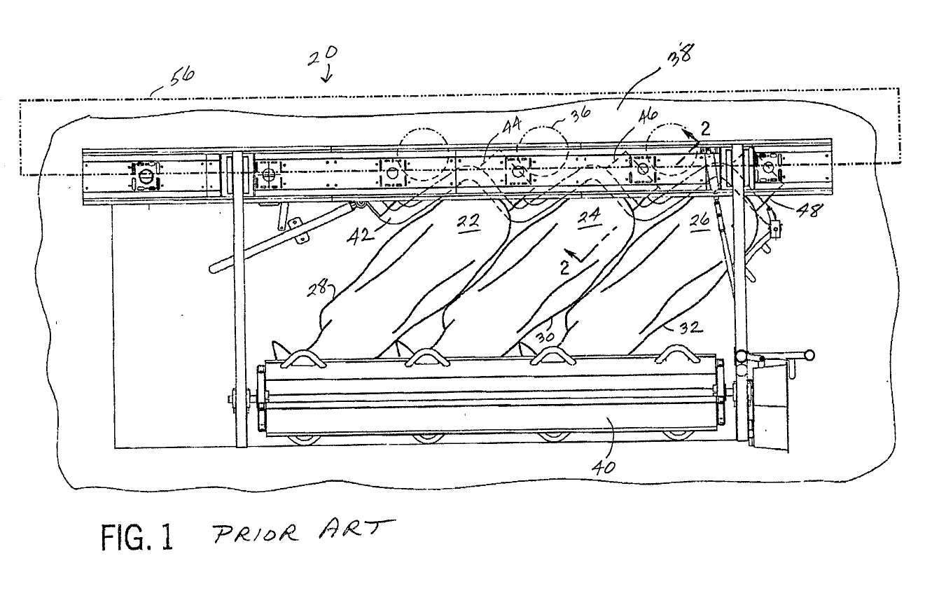

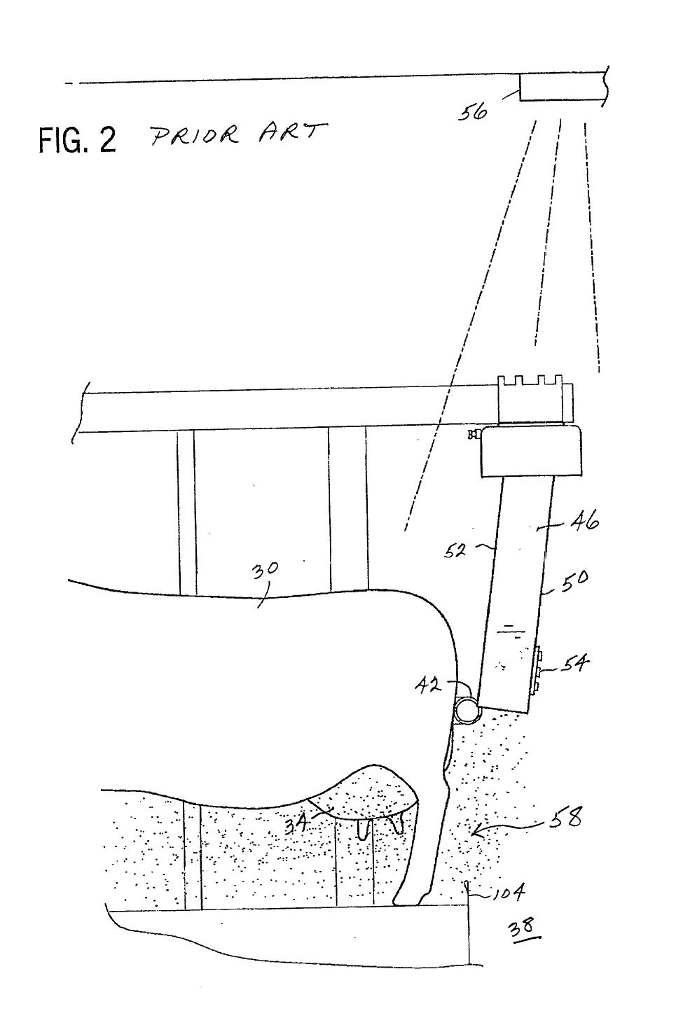

FIGS. 1 and 2 show a milking parlor 20 known in the prior art. A plurality of stalls 22, 24, 26 etc., hold cows 28, 30, 32 respectively, etc. such that the cows' udders such as 34, FIG. 2 are accessible to an operator as shown at 36 in pit 38, for which further reference may be had to U.S. Pat. No. 5,203,280, incorporated herein by reference. The particular parlor shown is of the herringbone type, and movement of the cows into and out of the parlor is controlled by exit gate or reel 40, corresponding to gate 20 in the noted incorporated '280 patent. The stalls have a zigzag or S-shape rump rail 42 corresponding to rump rail 16 in the noted incorporated '280 patent. The stalls have cabinets 44, 46, 48, etc. with a front control panel such as 50 facing the operator, and a rear splash panel 52 facing the rump of the cow. The control panel typically includes a key pad 54 or the like for various control functions for that stall, such as retraction or extension of the milking cluster including the claw and teatcups (not shown), application of milking vacuum, pulsation vacuum, etc., all as is known.

Lighting fixtures such as 56 are suspended overhead. As shown in FIG. 2 the light beams from light 56 cannot effectively reach the cow's udder 34 because the light is blocked by the body of the cow above the udder and/or portions of the stalls therebetween, resulting in shadowed region 58 as shown by stippling.

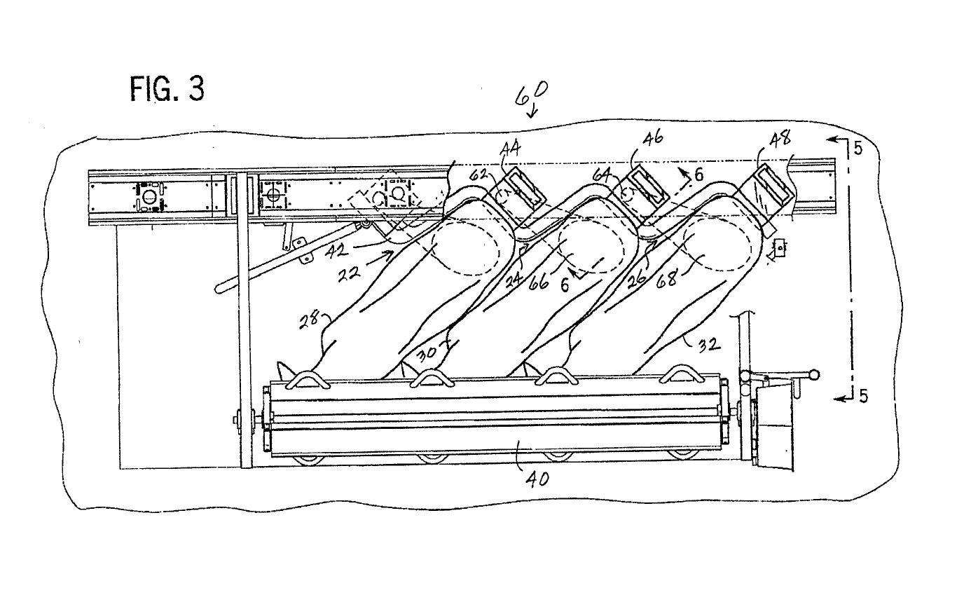

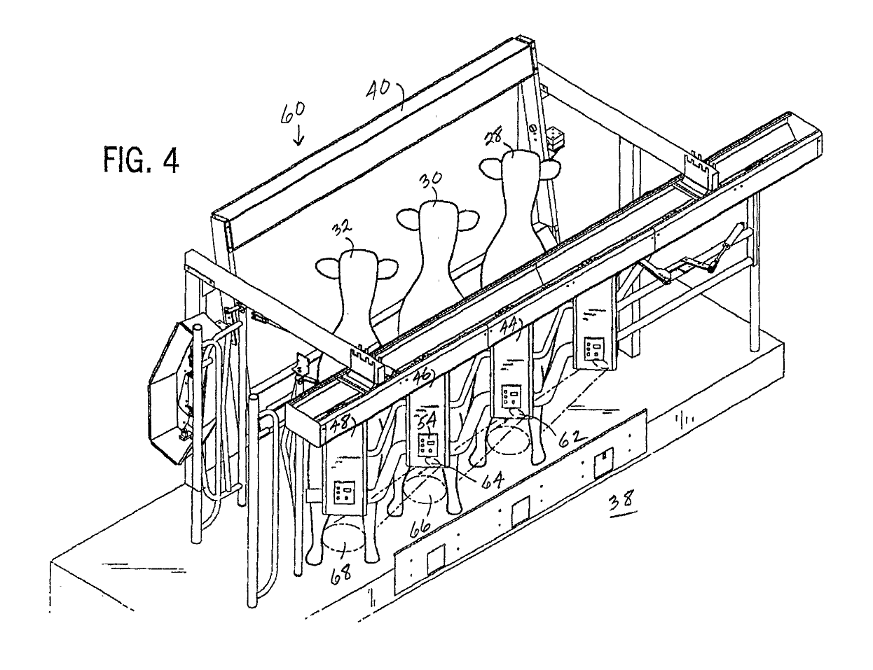

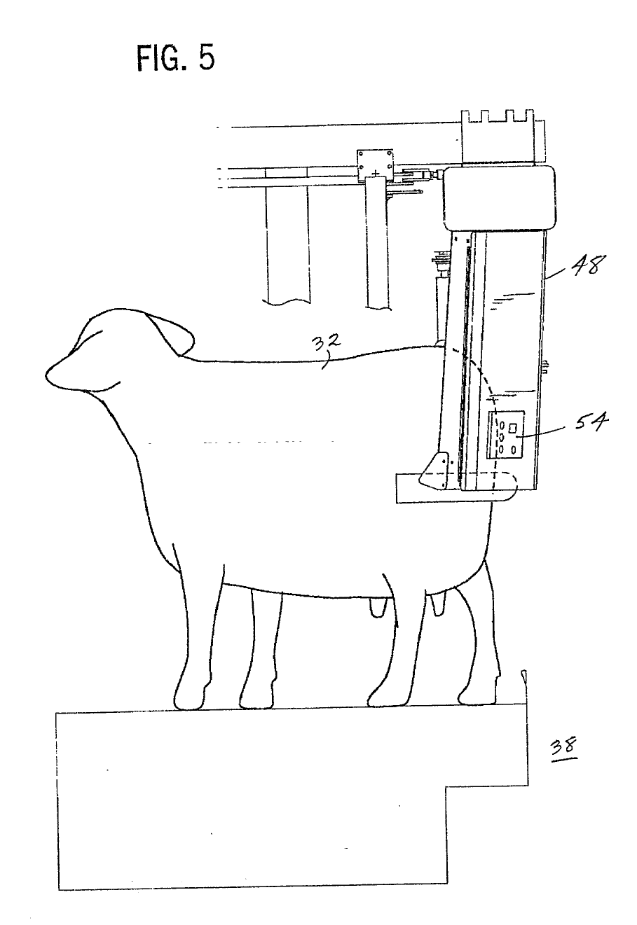

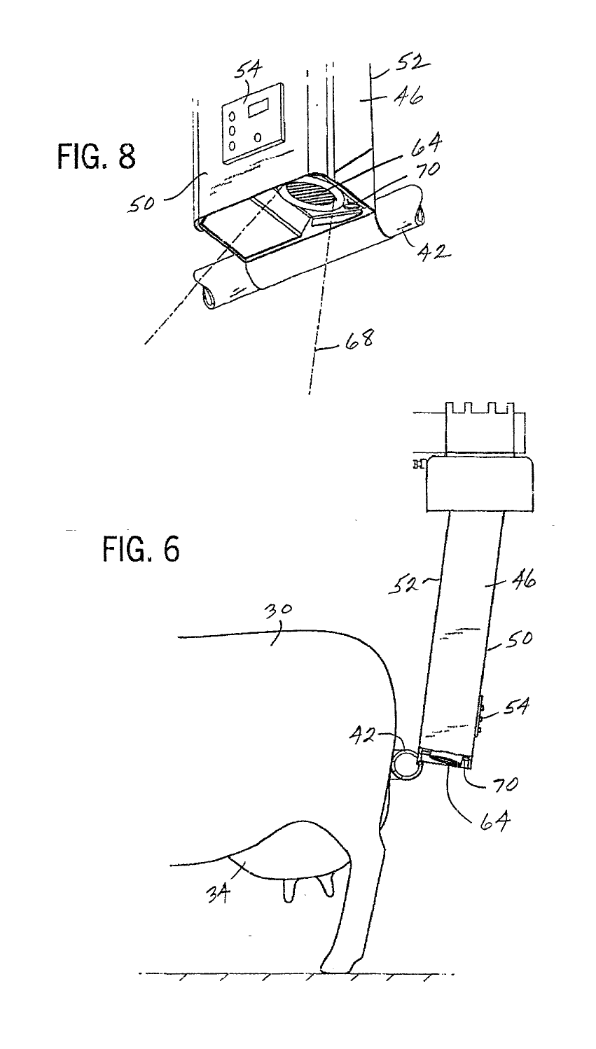

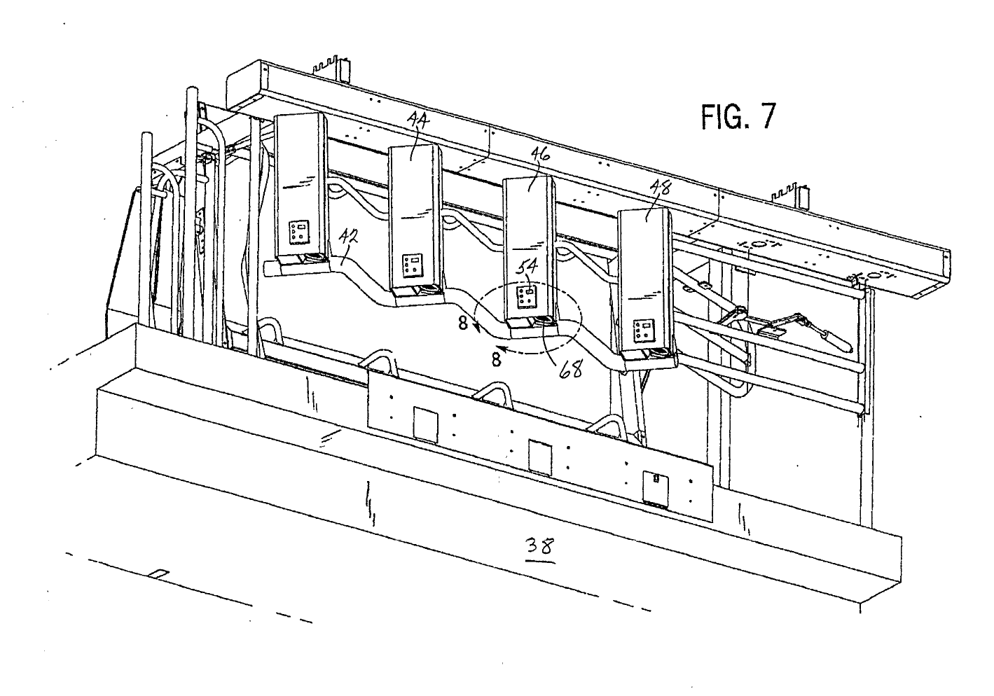

FIGS. 3-11 illustrate the present invention and use like reference numerals from above where appropriate to facilitate understanding. Stalls 22, 24, etc. in milking parlor 60 in FIG. 3 have lights 62, 64, etc., directly illuminating the cows' udders for viewing by the operator in the pit, as shown at respective illumination regions 66, 68, etc., FIGS. 3, 4, 6. The lights are beneath the rioted splash panels such as 52 of the stalls, FIG. 6, and direct light beams downwardly and diagonally toward the udder of the cow in the adjacent stall. The lights are mounted to the splash panels at a location above the udder, FIG. 6, and below the top of the rump of the cow. The stalls have the noted cabinets 44, 46, etc., with the noted front control panel such as 50, FIGS. 6, 8, facing the operator in the pit, the rear splash panel 52 facing the rump of the cow, and a bottom 70 extending between control panel 50 and splash panel 52 and facing downwardly. The lights such as 64 are mounted to the cabinet bottoms such as 70.

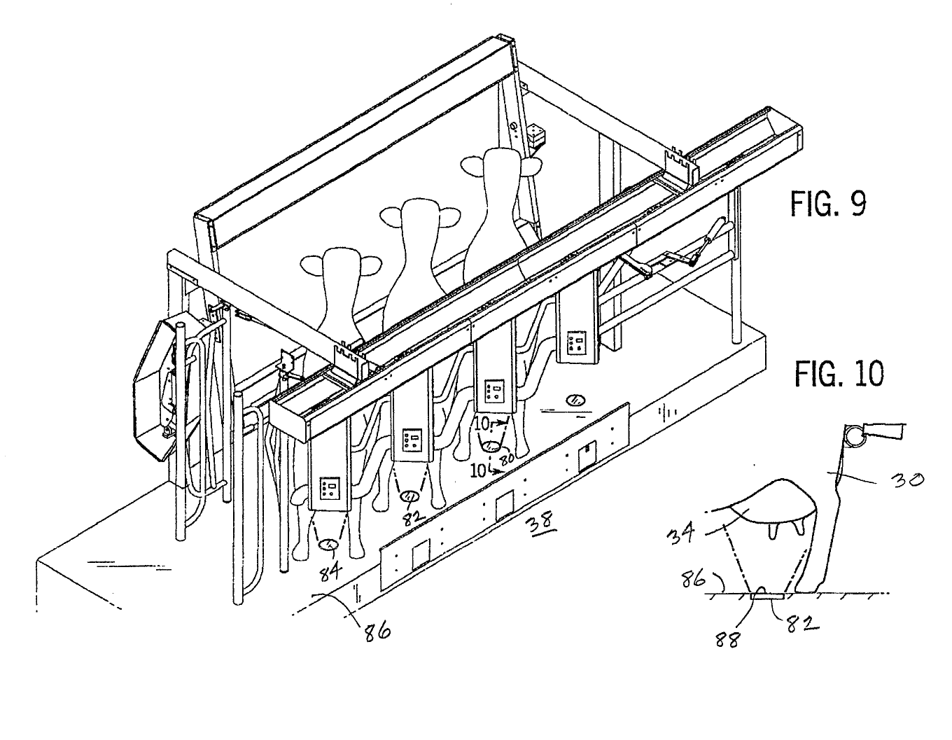

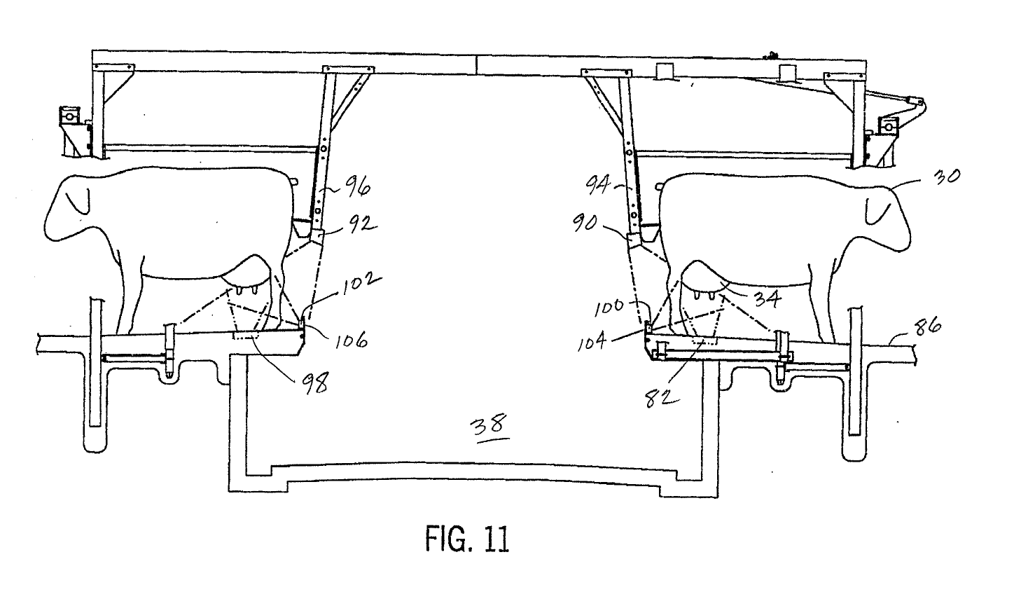

In an alternate embodiment, FIGS. 9, 10, lights 80, 82, 84 are in the floor 86 of the stalls. Lights 80, 82, 84 direct light beams upwardly toward the cows' udders. The lights have upper surfaces such as 88, FIG. 10, flush with floor 86, so that the cows do not trip over the lights.

In a further embodiment as shown in FIG. 11, lights such as 90, 92 are mounted to stall rump rails 94, 96 and direct light beams downwardly and diagonally toward the cows' udders and away from the pit. Lights such as 82, 98 may additionally provided in the floor in FIG. 11 and/or FIGS. 3-8. In a further embodiment, lights such as 100, 102, are provided on curbs 104, 106, FIGS. 11, 2, and direct light beams upwardly and diagonally toward the cows' udders and away from the pit.

The lights in FIGS. 3-11 are spaced from the cows' udders along illumination paths including a plurality of rectilinear paths unblocked by the cows' body above the udder. It is preferred that as many of such rectilinear paths between the lights and the udders also be unblocked by any other portion of the cow therebetween and unblocked by any other portion of the stall therebetween.

It is recognized that various equivalents, alternatives and modifications are possible within the scope of the appended claims.

What is claimed is:

1. A milking parlor comprising a plurality of stalls for holding cows such that the cow's udders are accessible to an operator in a pit, said stalls having lights directly illuminating said udders for viewing by said operator.

2. The invention according to claim 1 wherein said stalls have splash panels at the rumps of the cows, and wherein said lights are beneath said splash panels.

3. The invention according to claim 2 wherein said lights, direct light beams downwardly and diagonally towards said udders.

4. The invention according to claim 1 wherein said stalls have splash panels at the rumps of the cows and wherein said lights are mounted to said splash panels at a location above the udder and below the top of the rump.

5. The invention according to claim 1 wherein said stalls have cabinets with a front control panel facing said operator, a rear splash panel facing the rump of the cow, and a bottom extending between said control panel and said splash panel and facing downwardly and wherein said lights are mounted to said cabinet bottoms.

6. The invention according to claim 1 wherein said stalls have a floor, and wherein said lights are in said floor.

7. The invention according to claim 6 wherein said lights direct light beams upwardly toward said udders.

8. The invention according to claim 7 wherein said lights have an upper surface flush with said floor.

9. The invention according to claim 1 wherein said stalls have a rump rail facing the cows' rumps, and said lights are along said rump rail.

10. The invention according to claim 9 wherein said lights direct light beams downwardly and diagonally toward said udders and away from said pit.

11. The invention according to claim 1 wherein said stalls have a curb along said pit, and said lights are along said curb.

12. The invention according to claim 11 wherein said lights direct light beams upwardly and diagonally toward said udders and away from said pit.

13. The invention according to claim 1 wherein said lights are spaced from said udders along illumination paths comprising a plurality of rectilinear paths unblocked by the cow's body above the udder.

14. The invention according to claim 13 wherein said rectilinear paths between said lights and said udders are unblocked by any other portion of the cow therebetween.

15. The invention according to claim 13 wherein said rectilinear paths between said lights and said udders are unblocked by any other portion of the stall therebetween.

16. A method of milking cows comprising providing a milking parlor having a plurality of stalls for holding cows such that the cows' udders are accessible to an operator in a pit, comprising providing lights in said stalls, and directly illuminating the udders for viewing by the operator.

17. The method according to claim 16 comprising providing said stalls with splash panels at the rumps of the cows, and providing said lights beneath said splash panels.

18. The method according to claim 17 comprising directing light beams downwardly and diagonally from said lights toward said udders.

19. The method according to claim 16 comprising providing said stalls with splash panels at the rumps of the cows, and mounting said lights to said splash panels at a location above the udder and below the top of the rump.

20. The method according to claim 16 comprising providing said stalls with cabinets having a front control panel facing the operator, a rear splash panel facing the rump of the cow, and a bottom extending between said control panel and said splash panel and facing downwardly, and mounting said lights to said cabinet bottoms.

21. The method according to claim 16 comprising providing said stalls with a floor, and providing said lights in said floor.

22. The method according to claim 21 comprising directing light beams upwardly from said lights toward said udders.

23. The method according to claim 22 comprising providing said lights with an upper surface flush with said floor.

24. The method according to claim 16 comprising providing said stalls with a rump rail facing the cows' rumps, and providing said lights along said rump rail.

25. The method according to claim 24 comprising directing the light beams downwardly and diagonally from said lights toward said udders and away from said pit.

26. The method according to claim 16 comprising providing said stalls with a curb, and providing said lights along said curb.

27. The method according to claim 26 comprising directing the light beams upwardly and diagonally from said lights toward said udders and away from said pit.

28. The method according to claim 16 comprising spacing said lights from said udders along illumination paths comprising a plurality of rectilinear paths unblocked by the cow's body above the udder.

29. The method according to claim 28 comprising providing said rectilinear paths between said lights and said udders unblocked by any other portion of the cow therebetween.

30. The method according to claim 28 comprising providing said rectilinear paths between said lights and said udders unblocked by any other portion of the stall therebetween.
